(19) United States
(12) Patent Application Publication
(10) Pub. No.: US 2012/0138548 A1
(43) Pub. Date: Jun. 7, 2012

(54) SKI, SKI POLE, AND/OR SNOWBOARD LOCK

(76) Inventor: David Young, Glasgow (GB)

(21) Appl. No.: 13/387,603

(22) PCT Filed: Jul. 26, 2010
(86) PCT No.: PCT/GB10/51230

§ 371 Date: Feb. 7, 2012

(30) Foreign Application Priority Data
Jul. 31, 2009 (GB) 0913329.9
Nov. 18, 2009 (GB) 0920183.1

(51) Int. Cl. A63C 11/00; E05B 73/00

(52) U.S. Cl. 211/4

(57) ABSTRACT

There is herein described a method and apparatus for locking and safely securing sports equipment. More particularly, there is herein described a method and apparatus for locking and safely securely skis, skis and ski poles, ski poles and/or snowboards thereby preventing theft. A support and a locking mechanism connected to it are provided. The locking mechanism is capable of being activated using a wireless control means.

### FIELD OF THE INVENTION

The present invention relates to a method and apparatus for locking and safely securing sports equipment. More particularly, the present invention relates to a method and apparatus for locking and safely securing skis, skis and ski poles, ski poles, and/or snowboards thereby preventing theft.

### BACKGROUND OF THE INVENTION

Skiing and snowboarding are extremely popular winter sports. It is estimated that there are over 200 million skiers worldwide. At present when skiers and snowboarders wish to go to a restaurant or cafe etc, they have few options to secure their skis and snowboards. As a result, skis and snowboards are invariably left unattended and unsecured leading to their possible theft.

Various devices currently exist in the art. However, these previous devices are limited in their use for securing skis, ski poles and/or snowboards. For example, these prior art devices take the form of (1) a fully enclosed locker; (2) a rack consisting of fixed brackets with coin operated hinged doors; (3) a rack which requires the user to pre-purchase a padlock for use with the rack; and (4) a portable cable lock.

Other devices have been designed, although they are not in current use, to secure skis to prevent theft. These devices all have common characteristics and are similar in form to the devices described above. These devices consist of a rack which has a series of lockable metal brackets. The rack is designed so that the butt of the skis rests on a holder. The top half of the skis are then placed into a metal bracket. Each bracket has a hinged door or lever which can be closed and locked. The hinged doors or fevers may include coin operated locks.

The anti-theft devices currently in use and other current designs all have significant disadvantages. For example, lockers are expensive, bulky and obtrusive. They also require considerable installation work which also adds to their expense. Moreover, snow can drift against the lockers rendering them unusable. Racks consisting of fixed brackets requiring the skis to rest on a holder are not adjustable and cannot accommodate varying lengths of skis. Keys are also small and awkward to use in these types of devices. The keys can also be easily lost and skeleton keys and replacements are therefore required when loss occurs. The racks also cannot accommodate some new types of snowboards. A rack which requires a user to pre-purchase a padlock for its use can be tricky to operate as these types of devices involve a user pushing and pressing a metal bar through a slot and ensuring that the padlock engages with the metal bar. The padlocks may also be lost or simply forgotten. Portable cable locks also have disadvantages in that a user is required to carry them on their own person at all times. Portable cable locks typically consist of a three-wheel combination lock which is awkward to use, the codes can be forgotten and the wire cable may also be easily cut.

It is an object of at least one aspect of the present invention to obviate or mitigate at least one or more of the aforementioned problems.

It is a further object of at least one aspect of the present invention to provide an improved ski, ski pole and/or snowboard lock which provides a secure anti-theft device.

It is a yet further object of at least one aspect of the present invention to provide a secure ski, ski pole and/or snowboard lock which requires minimal installation, is easy to maintain and is also adjustable for different weather conditions and snow conditions.

It is a further object of at least one aspect of the present invention to provide an improved and secure ski, ski pole and/or snowboard lock which is unobtrusive and is simple and easy to use.

It is a further object of at least one aspect of the present invention to provide a secure ski, ski pole and/or snowboard lock which will accommodate different sizes and types of skis, skis and ski poles, ski poles, and/or snowboards.

### SUMMARY OF THE INVENTION

According to a first aspect of the present invention there is provided a secure ski, ski pole and/or snowboard locking apparatus, said secure ski, ski pole and/or snowboard locking apparatus comprising:

a support;

at least one Locking mechanism connected to the support, said at least one locking mechanism capable of securely locking at least one or more skis, skis and ski poles, ski poles, and/or snowboards;

wherein said at least one locking mechanism is capable of being activated using a wireless control means.

The present invention therefore relates to a secure ski, ski pole and/or snowboard locking apparatus which is capable of preventing theft and being activated using a wireless control means.

Typically, the wireless activation means may be any form of electronic wireless control means such radio-frequency identification (RFID) systems including that of cards or tags.

The ski, ski pole and/or snowboard locking apparatus comprises a support which may include at least two or more or a plurality of vertical or substantially vertical legs.

Attached to the legs of the ski, ski pole and/or snowboard locking apparatus there may be at least one or more horizontal or substantially horizontal support members. Onto the horizontal or substantially horizontal support members there may be at least one or more, at least two or more or a plurality of locking mechanisms which are capable of securely locking at least one or more skis, skis and ski poles, ski poles, and/or snowboards.

The locking mechanisms may be any suitable mechanical means which are capable of engaging with and clamping onto at least one or more skis, skis and ski poles, ski poles, and/or snowboards. In particular embodiments, the locking mechanism may be a rotational locking mechanism comprising a series of ‘U’-shaped members. The ‘U’-shaped members may therefore form a snug fit around the skis, skis and ski poles, ski poles, and/or snowboards.

In particular embodiments the apparatus may comprise a series of locking members which may comprise a first compartment (e.g. a long slot) for a snowboard, a second slot for ski pole(s) and a third slot for a ski or a pair of skis. The locking apparatus may comprise a latch which may be spring loaded and which may remain in an upright (e.g. open) position when unused and empty. In use, once a skier or snowboarder has placed a at least one or more skis, skis and ski poles, ski poles, and/or snowboards into the respective slots in the locking mechanism, they may then push down the latch which locks a locking mechanism of the locking member. Any suitable shape and or type of slot and/or compartment may be utilised in the locking member which may be used to securely store any one of or combination of skis, skis and ski poles, ski poles, and/or snowboards.

In particular embodiments, the locking mechanism may comprise a fixed clamp at the front of a strut and a back clamp which may move backwards and forwards along the strut. The skis, skis and ski poles, ski poles, and/or snowboard may be clamped securely between the front and back clamp.

The operation of the locking mechanism may be controlled by a pre-paid electronic wireless system including that of an RFID card or tag. Payment may either be made with each swipe of the RFID card or tag over a receiver, or alternatively, a skier/snowboarder may pre-purchase an RFID card or tag (‘Lok Pass’) for a pre-determined period of time (e.g. 24 hrs). The skier/snowboarder can then use any of the locking apparatus within the resort as many times and for as long as they wish throughout the period the ‘Lok Pass’ is valid. On expiry of the ‘Lok Pass’ the skier/snowboarder can still remove their equipment if secured in a locking apparatus but they will not be able to use the locking apparatus again until they purchase another ‘Lok-Pass’ In particular embodiments the locking mechanism may become operational when the RFID card or tag is scanned across a receiver on the locking apparatus of the ski, ski pole and/or snowboard lock which may identify the specific user and therefore may enable an empty space for a skier or snowboarder to use to store skis, skis and ski poles, ski poles, and/or snowboards.

The ski, ski pole and/or snowboard lock may also comprise a series of LED lights which may be used to notify skiers and snowboarders when locks are available and unavailable.

The ski, ski pole and/or snowboard locks may also comprise a solar panel which may be used to power the ski, ski pole and/or snowboard locking mechanism. However any means may be used to power the locking apparatus including that of solar, wind, battery and/or a fixed electrical source.

According to a second aspect of the present invention there is provided a method of securing skis, skis and ski poles, ski poles, and/or snowboards said method comprising:

providing a support;

providing at least one locking mechanism connected to the support, said at least one locking mechanism capable of securely locking at least one or more skis, skis and ski poles, ski poles, and/or snowboards; and

wherein said at least one locking mechanism is capable of being activated using a wireless control means.

Typically, the method may use the ski, ski pole and/or snowboard locking apparatus described in the first aspect.

According to a third aspect of the present invention there is provided use of the ski, ski pole and/or snowboard locking apparatus described in the first aspect in the secure storage of at least one or more skis, skis and ski poles, ski poles, and/or snowboards.

### BRIEF DESCRIPTION OF THE DRAWINGS

Embodiments of the present invention will now be described, by way of example only, with reference to the accompanying drawings in which:

FIG. 1 is a representation of a ski, ski pole and/or snowboard lock apparatus according to an embodiment of the present invention;

FIG. 2 is a top end view of a locking mechanism shown in the apparatus of FIG. 1;

FIG. 3 is a further expanded view of the ski, ski pole and/or snowboard locking apparatus shown in FIG. 1 showing the locking mechanism;

FIG. 4 is a representation of a solar panel in the apparatus as shown in FIG. 1;

FIG. 5 is a representation of a ski, ski pole and/or snowboard lock apparatus according to a further embodiment of the present invention;

FIGS. 6 and 7 are views of a locking mechanism forming part of the apparatus shown in FIG. 5;

FIG. 8 is a top view of the locking mechanism shown in FIGS. 6 and 7;

FIG. 9 is a representation of a ski, ski pole and/or snowboard lock apparatus according to a yet further embodiment of the present invention in use;

FIG. 10 is a representation of a ski, ski pole and/or snowboard lock apparatus according to a yet further embodiment of the present invention;

FIG. 11 is a top view of the apparatus shown in FIG. 10;

FIG. 12 is a view of a back clamp according to a further embodiment of the present invention wherein the back clamp is attached to a metal strut along which the back clamp slides;

FIG. 13 is a view of the back clamp shown in FIG. 12 with the metal strut removed so that the metal extension spring and power cables are visible;

FIGS. 14 to 16 are further views of the clamp mechanism shown in FIGS. 12 and 13; according to a further embodiment of the present invention;

FIG. 17 is a side sectional view of the clamp mechanism shown in FIGS. 14 to 16;

FIG. 18 is an exploded view of the clamp mechanism shown in FIGS. 14 to 17;

FIG. 19 is a view of a front clamp wherein the front clamp is attached to a metal strut according to the present invention;

FIG. 20 is a view of the front clamp shown in FIG. 19 with the metal strut removed so that the power cables are visible

FIG. 21 is a view of a ski, ski pole and/or snowboard lock apparatus according to the present invention;

FIGS. 22 and 23 are expanded views of part of the ski, ski pole and/or snowboard lock apparatus shown in FIG. 21 showing the locking mechanism;

FIG. 24 is a view of a ski, ski pole and/or snowboard lock apparatus according to a further embodiment of the present invention;

FIG. 25 is a view of a ski, ski pole and/or snowboard lock apparatus according to a further embodiment of the present invention; and

FIGS. 26 and 27 are views of a clamp mechanism according to a further embodiment of the present invention.

### BRIEF DESCRIPTION

Generally speaking, the present invention therefore resides in the provision of a method and an apparatus for securely storing at least one or more skis, skis and ski poles, ski poles, and/or snowboards using a ski, ski pole and/or snowboard lock which is operated using a wireless control means.

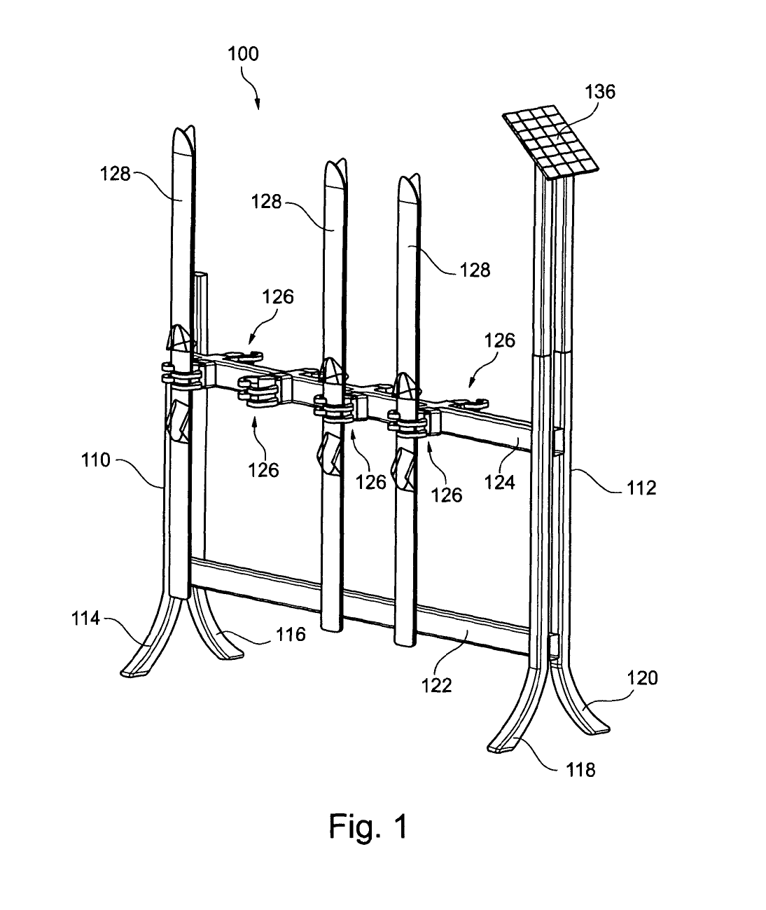

As shown in FIG. 1, there is a ski, ski pole and/or snowboard locking apparatus according to the present invention, generally designated 100. FIG. 1 shows that the apparatus 100 comprises two substantially vertical legs 110, 112. Vertical leg 110 has two bottom supports 114, 116 and vertical leg 112 also has two supports 118, 120. The supports 114, 116, 118, 120 provide stability.

FIG. 1 also shows that the apparatus 100 comprises a lower support member 122 in the form of a horizontal strut and an upper support member 124. The upper support member 124 is substantially horizontal and is attached to the legs 110, 112. The position of the support 124 may be adjusted on the legs 110, 112 to accommodate different lengths of skis, skis and ski poles, ski poles and/or different lengths and sizes of snowboards. The apparatus 100 is therefore capable of adapting to different types of skis, skis and ski poles, ski poles and/or snowboards.

Shown in FIG. 1 there are a series of locking mechanisms 126. Three of the locking mechanisms 126 in FIG. 1 are shown in the activated position and are shown holding skis 128. The locking mechanisms 126 may be designed to be located around the middle of bindings of a ski and/or snowboard or above or below the bindings.

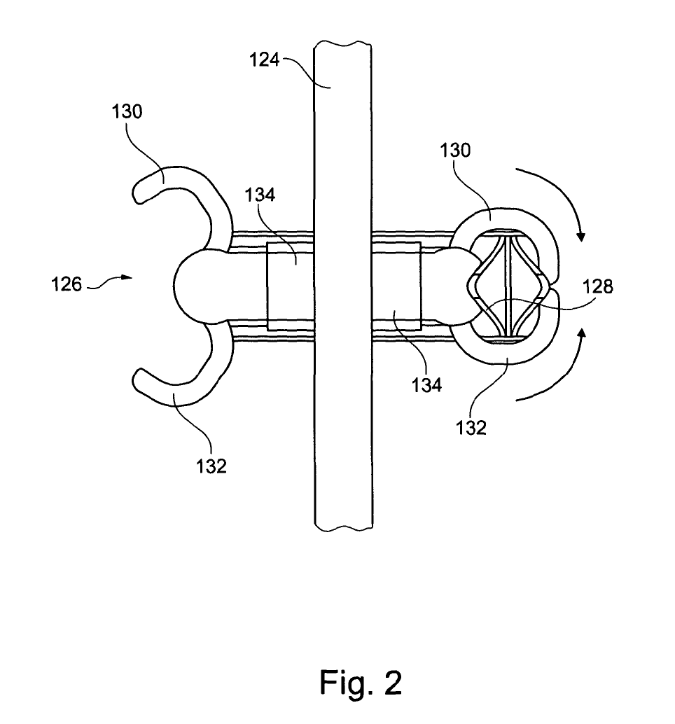

FIG. 2 is an expanded view of the locking mechanisms 126. The locking mechanisms 126 comprise two clamps 130, 132 which may be rotatable from an activated to an inactivated position. On the left-hand side of FIG. 2, the locking mechanism 126 is shown in an inactivated position whereas on the right-hand side in FIG. 2, the locking mechanism 126 is shown in the activated position and the clamps 130, 132 are shown gripping a pair of skis 128.

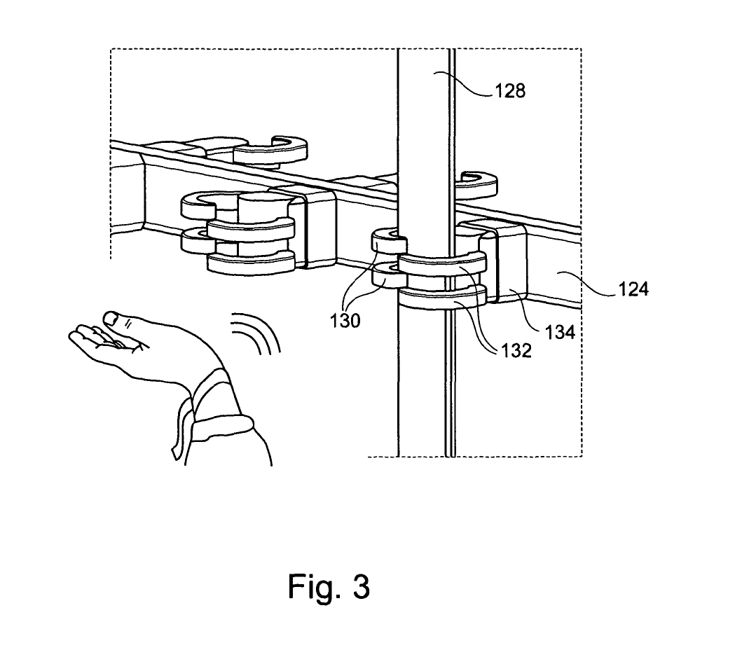

FIG. 3 is a further representation of the clamps 126 and shows that the clamps 130, 132 on each side of the locking mechanism comprise two separate ‘U’-shaped members that are used to grip at least one or more skis, skis and ski poles, ski poles, and/or snowboards. The locking mechanisms 126 are attached to the horizontal support 124 using connecting members 134.

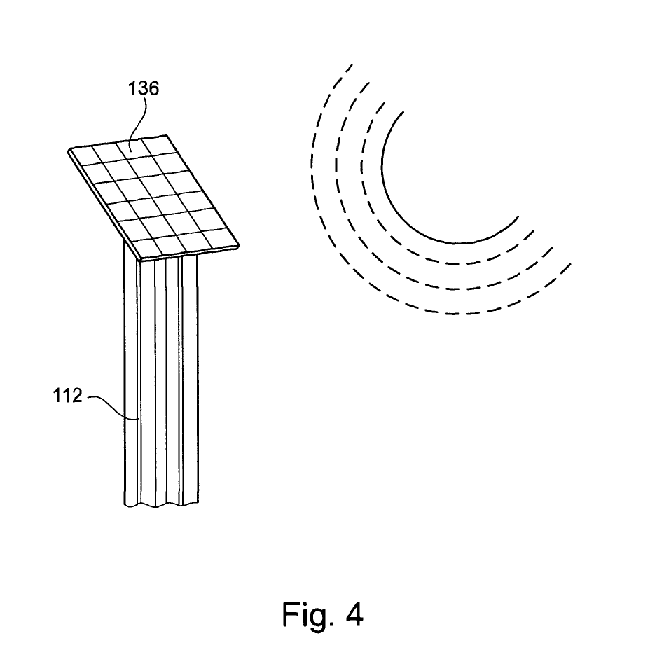

FIG. 4 is a further representation of the solar panel 136 used to operate the locking mechanism 126 in the apparatus 100.

The operation of the locking mechanisms may be controlled by a pre-paid electronic wireless system such as a valid RFID card or tag. Payment may either be made with each swipe of the RFID card or tag over a receiver, or alternatively, a skier/snowboarder may pre-purchase an RFID card or tag (‘Lok Pass’) for a pre-determined period of time (e.g. 24 hrs). The skier/snowboarder can then use any of the locking apparatus within the resort as many times and for as long as they wish throughout the period the ‘Lok Pass’ is valid. On expiry of the ‘Lok Pass’ the skier/snowboarder can still remove their equipment if secured in a locking apparatus but they will not be able to use the locking apparatus again until they purchase another ‘Lok-Pass’. The locking mechanisms 126 will become operational when the valid RFID card or tag is scanned across a receiver. The receiver in some embodiments may be on the locking mechanisms 126. During this activation, the locking mechanism 126 may therefore move to an open position such as shown on the left-hand side of FIG. 2. On placing at least one or more skis, skis and ski poles, ski poles, and/or snowboards in the locking mechanism 126, the locking mechanism may itself automatically detect that a ski, skis and ski poles, ski poles, and/or snowboard has been placed in the locking mechanism 126 or alternatively, a further swipe of the RFID card or tag may activate the locking mechanism 126 into the locked position. Receivers on the apparatus 100 may be located at any suitable position but may, for example, be located at each individual locking mechanism 126 or at the end of the apparatus 100 controlling a certain number of locking mechanisms 126.

The apparatus 100 may also comprise a series of coloured LED lights which may be used to notify skiers and snowboarders as to which locks are available and unavailable for use. The LED lights may be located on the locking mechanisms 126.

Following payment, a user may place at least one or more skis, skis and ski poles, ski poles, and/or snowboards into the locking mechanism 126. The placing of the skis, skis and ski poles, ski poles, and/or snowboards may therefore be quick and intuitive to all users. Once the equipment has been placed in the correct position, either a manual ratchet mechanism or an electronically activated solenoid may be used to secure the locking mechanism 126 and thereby prevent the equipment from being removed and stolen.

Once at least one or more skis, skis and ski poles, ski poles, and/or snowboards have been placed and the locking mechanism 126 has been activated, the equipment may therefore be left unattended as it is now secured. The locking mechanism 126 will only release once a wireless message has been sent to the locking mechanism 126 to release. As indicated above, any suitable type of wireless means may be used but, for example, a RFID card or tag maybe used and scanned over a receiver to activate and deactivate the locking mechanism 126. Resort employees or tag distributors will also have access to the skiers or snowboarders account if RFID cards or tags need to be replaced or deactivated if misplaced.

The actual charge for the use of the apparatus 100 and the series of locking mechanisms 126 may be decided by each individual resort. Moreover, advertising space maybe included in the apparatus in order to fund the manufacturing and maintenance. The apparatus 100 may be manufactured from any suitable material including that of metal, alloy and/or plastics.

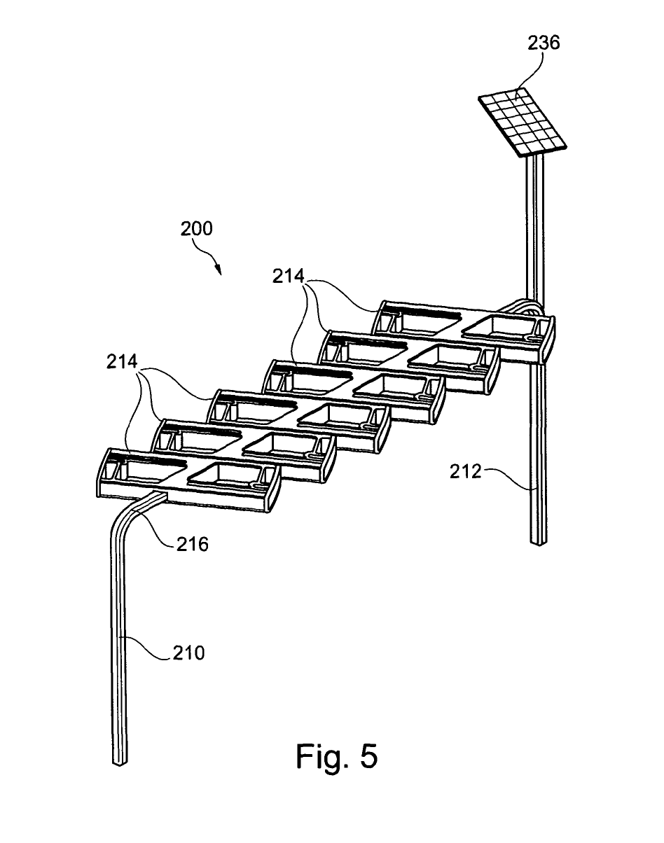

FIG. 5 is a representation of a ski, ski pole and/or snowboard locking apparatus according to a further embodiment of the present invention, generally designated 200. The apparatus 200 comprises two main supporting legs 210, 212 and an upper substantially horizontal supporting member 216. Located on the horizontal supporting member 216 there is a series of locking members 214. The apparatus 200 also has a solar panel device 236 which may power the apparatus 200.

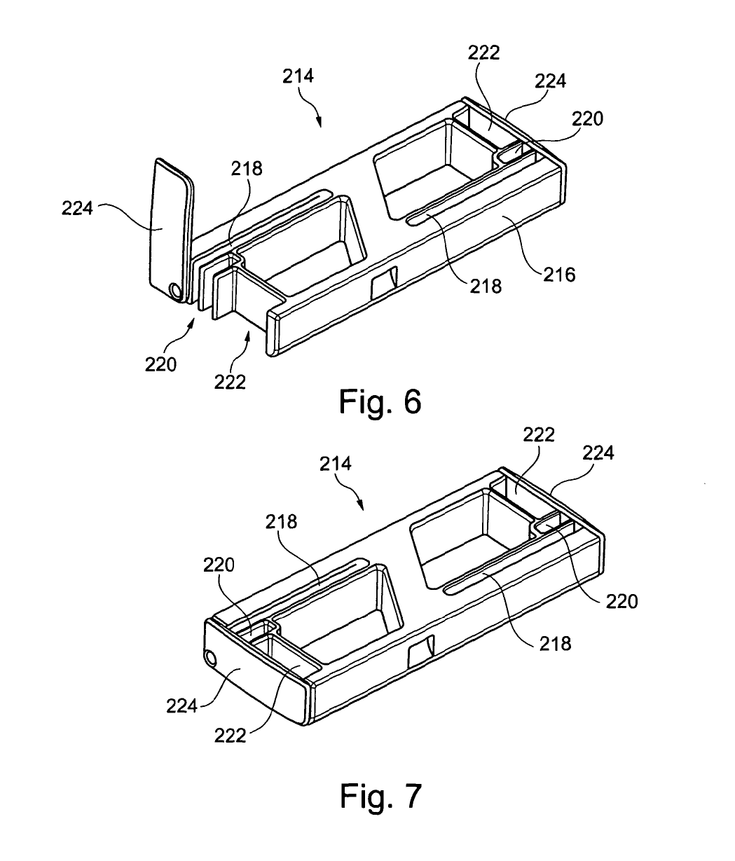

FIGS. 6 and 7 are more detailed views of the locking mechanisms 214. In FIG. 6 there is shown that the locking member 214 comprises a main body 216 wherein there are long slots 218 suitable for securely holding a snowboard, a second slot 220 suitable for securely holding a ski pole or pair of ski poles and a third slot 222 capable of securely holding a ski or pair of skis. As shown in FIG. 6 each side of the locking members 214 comprises a series of slots 218, 220, 222. FIG. 6 on the left-hand side also shows the latch 224 in an open position. In use the latch 224 may be pushed down and locked as shown in the right-hand side of FIG. 6. FIG. 7 is similar to FIG. 6 but shows the locking mechanism 214 in the locked position on the left-hand side.

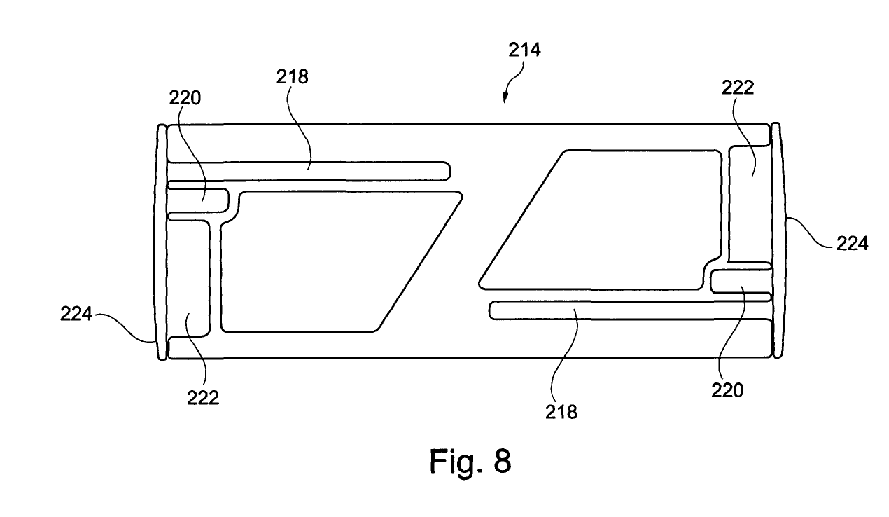

FIG. 8 shows a top view of the locking member 214 which clearly shows the long elongate slot 218 capable of securely fastening a snowboard, the second slot 220 capable of securely fastening a ski pole or a pair of ski poles and slot 222 capable of securely fastening a ski or a pair of skis.

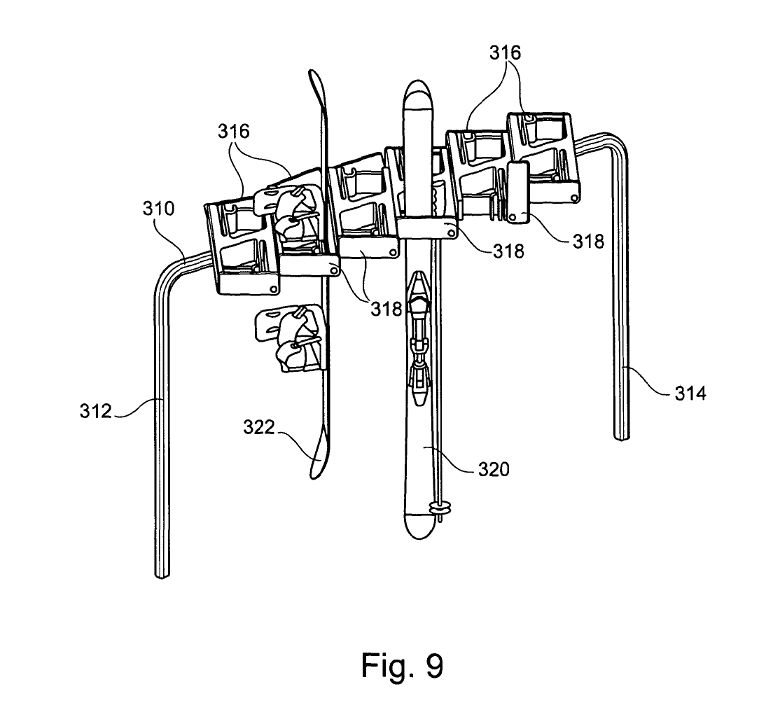

FIG. 9 is a representation of a further apparatus 300 wherein the apparatus 300 comprises a longitudinal member 310 and two extending legs 312, 314. Along the longitudinal member 310 there are a series of locking members 318. As shown in FIG. 9, one of the locking members 318 is used to hold a pair of skis 320 and another locking member 318 is used to hold a snowboard 322.

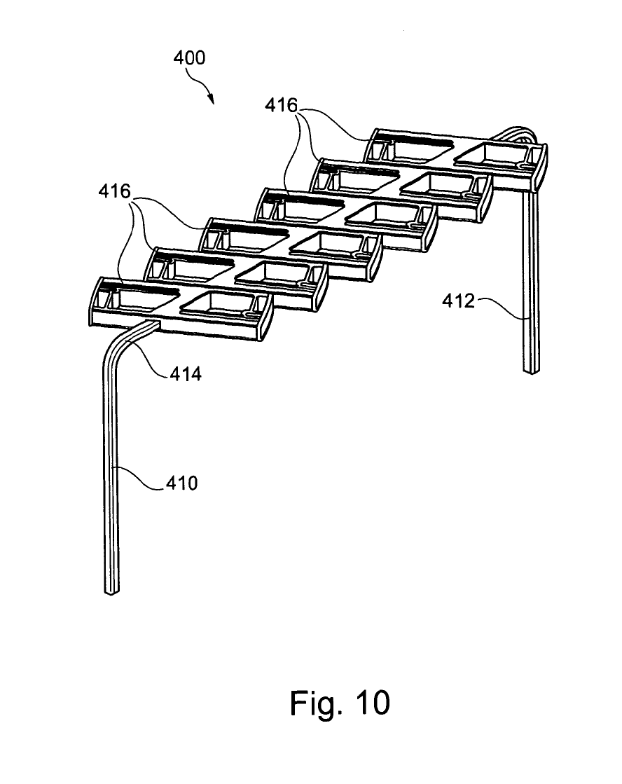

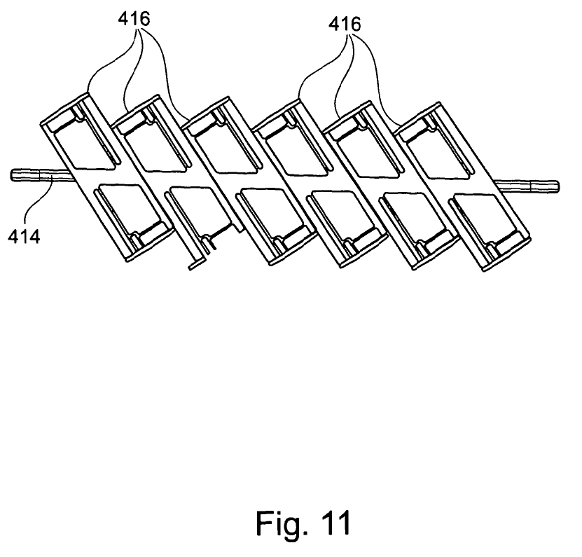

FIG. 10 is a representation of a further apparatus 400 capable of securely fastening at least one or more skis, skis and ski poles, ski poles, and/or snowboards. The apparatus 400 shown in FIG. 10 comprises two legs 410, 412 and an upper supporting member 414 along which there are located a series of locking members 416. FIG. 11 is a top view of the apparatus 400 and shows the locking members 416.

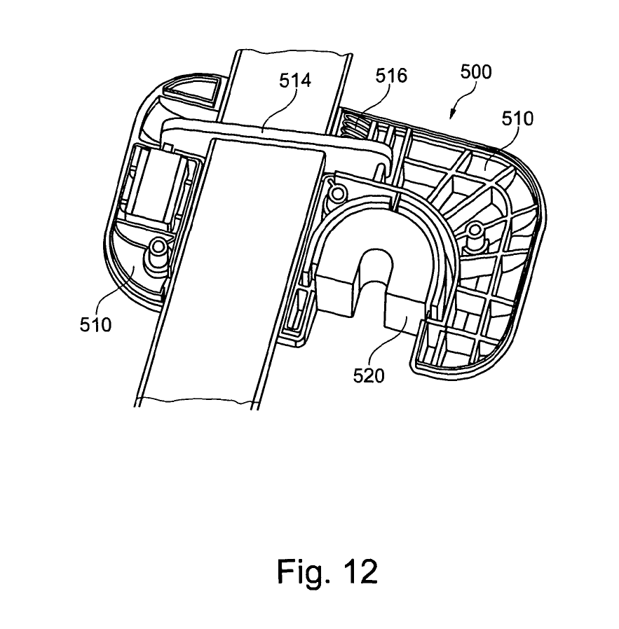

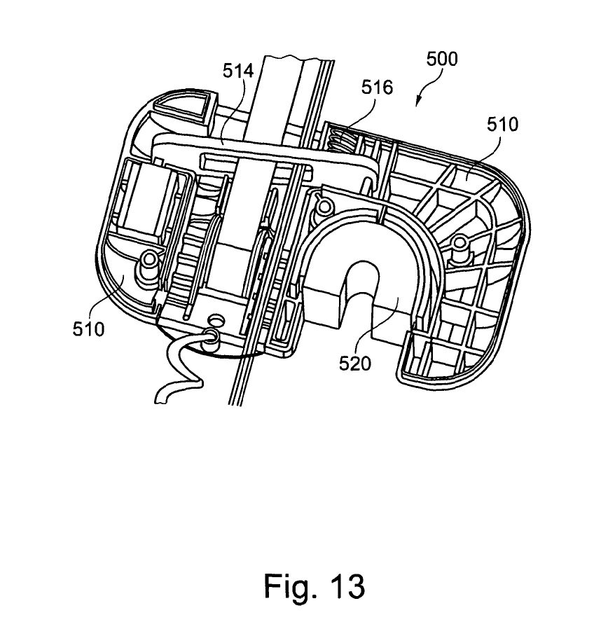

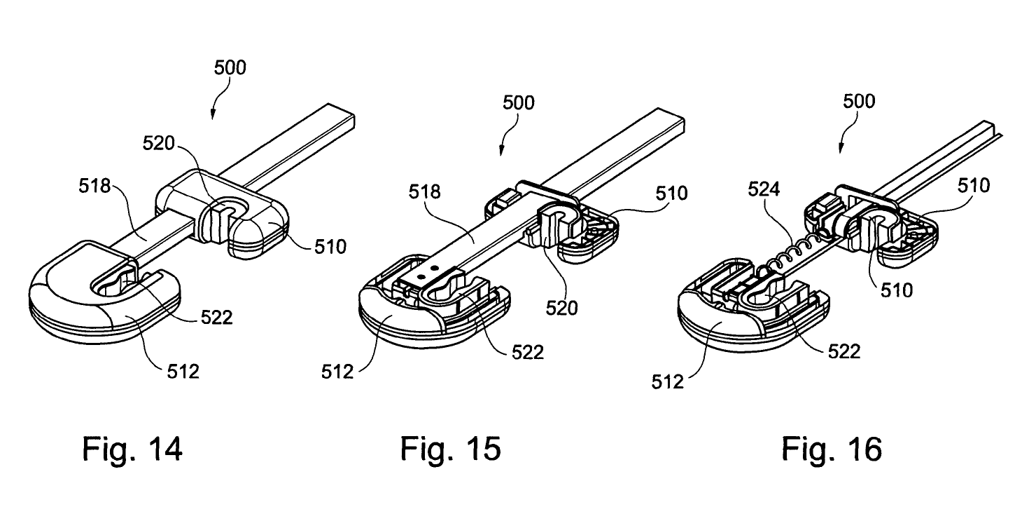

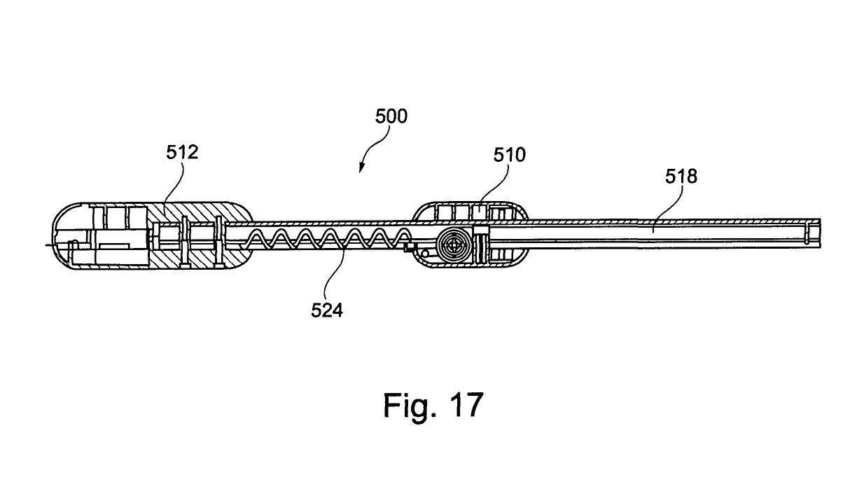

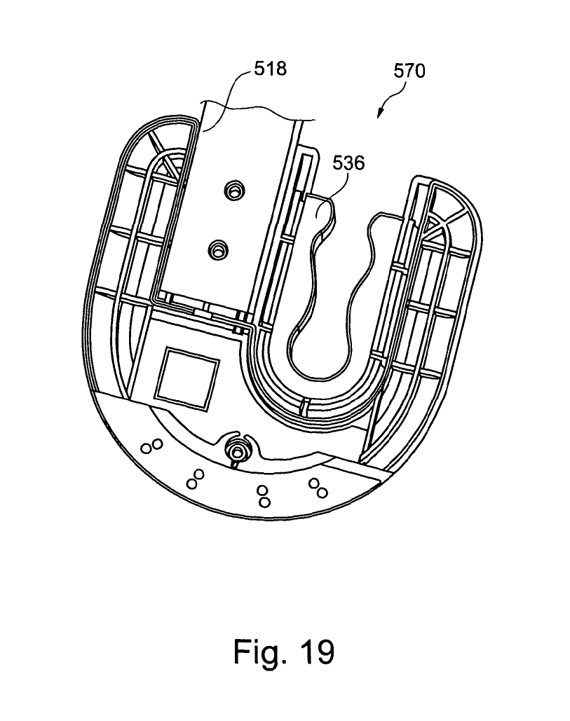

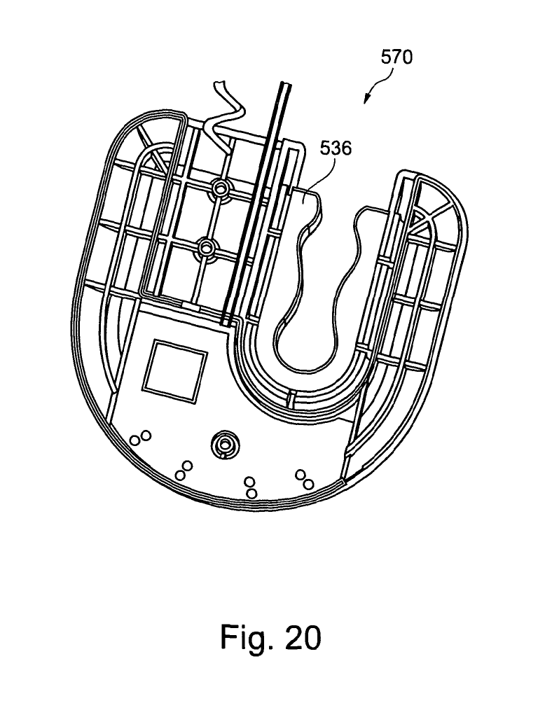

FIGS. 12 to 20, 26 and 27 represent a clamp 500 according to the present invention. As shown in FIGS. 14, 15 and 16, the clamp 500 comprises a back clamp 510 and a front clamp 512 that are bolted on either end of a strut 518 in such a way that the back clamp 510 can move easily backwards and forwards to engage onto articles such as skis, skis and ski poles or snowboards to be secured.

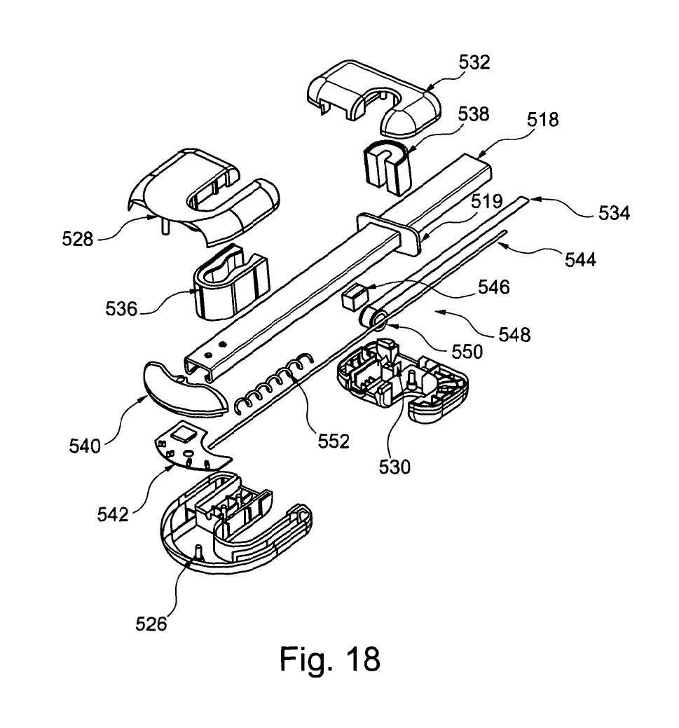

FIG. 18 is an exploded view of the different parts of the entire clamping mechanism which shows that the back clamp 510 comprises an upper portion 532 and a lower portion 530. The front clamp 512 comprises an upper portion 528 and a lower portion 526. The back and front clamps 510, 512 may be made by any suitable means such as injection plastics moulding or die casting. Connecting the back and front clamps 510, 512 there is shown a strut 518 which may be made from strong material such as stainless steel. Attached to the strut 518 there is shown a lock plate 519. A locking mechanism as shown in FIG. 18 comprises a front rubber grip 536 and a back rubber grip 538 which may be used to grip skis, skis and ski poles or snowboards. There is also shown a spiral cable 552 which may be connected between the back and front clamps 510, 512. The spiral cable 552 is a power cable which supplies power to and sends instructions to the solenoid/linear actuator. There is also shown an extension spring 534 which is connected to a spring drum 550. There is also shown a solenoid/linear actuator 546 and a compression spring 548. There is also shown a power supply 544, a light cover 540 and a PCB 542.

The locking mechanism consists of a back and front clamp 510, 512 and a strut 518. Inside the strut 518 is an extension spring 534 that is attached to a spring drum 550 in the back clamp 510 and a steel pin at the back of the strut 518. All available locks when not in use remain in the open position with the back clamp 510 sprung to the back of the strut 518. The back clamp 510 can freely move backwards and forwards along the strut 518 but will not lock in position thereby preventing unauthorised use. Inside the back clamp 518 is a solenoid or linear actuator and a steel plate which is under pressure from a spring. When a skier or snowboarder scans their RFID card or tag on the receiver located in the front clamp 512, the solenoid/linear actuator pin retracts allowing the spring to push the steel plate forward causing the steel plate to lock. The skier or snowboarder will then be able to pull the back clamp 510 forward and tighten it onto their skis, skis & ski poles or snowboard, but they will not be able to move the back clamp 510 backwards until they rescan their RFID card or tag.

There may be two sets of four lights located in the front clamp 512 which may alternate between red and green when locked and unlocked. A frosted plastic cover 540 diffuses the lights making it clear when the locks are available and unavailable.

The rubber grip 536 in the front clamp 512 is designed to hold two ski poles within the figure eight space whilst pushing against a pair of skis being clamped from the back. The same figure of eight space has been designed to tightly hold a snowboard between the bindings. The back clamp 510 has a rubber grip 538 that can either be pushed against the back of two skis to securely clamp them or can hold a snowboard firmly within the middle.

When the skier or snowboarder rescans their RFID card or tag the solenoid/linear actuator pin 546 pushes forward against the spring loaded steel plate 519 and holds out until activated again. When the steel plate 519 is unlocked the extension spring 534 pulls the back clamp 510 to the back of the strut 518 by pushing against a barrier within the clamp.

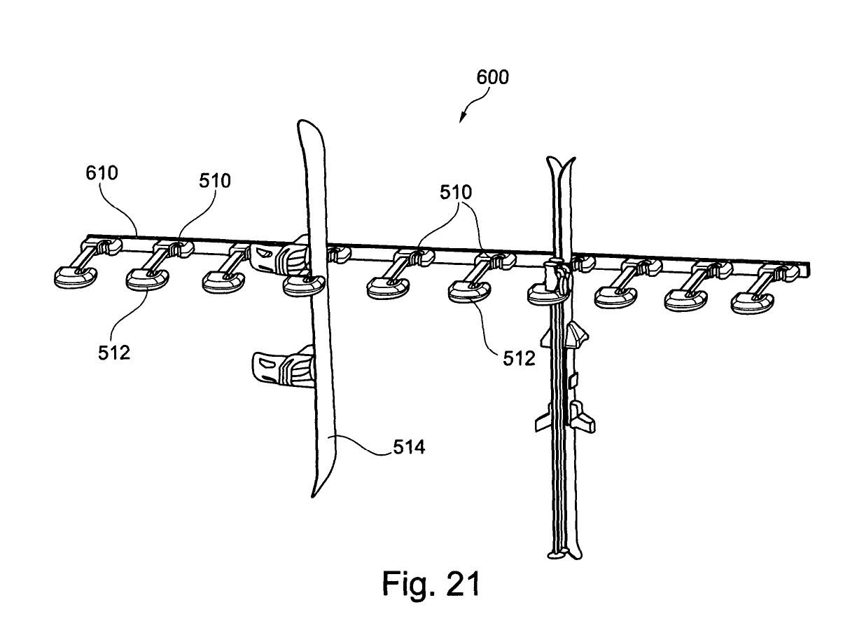

FIG. 21 is a representation of further apparatus 600 according to the present invention capable of securely fastening skis, skis and ski poles or snowboards. As shown in FIG. 21, there is a horizontal supporting member 610 onto which there are a plurality of locking members comprising a back clamp 510 and a front clamp 512 which may be used to engage with and hold skis, skis and ski poles or snowboards.

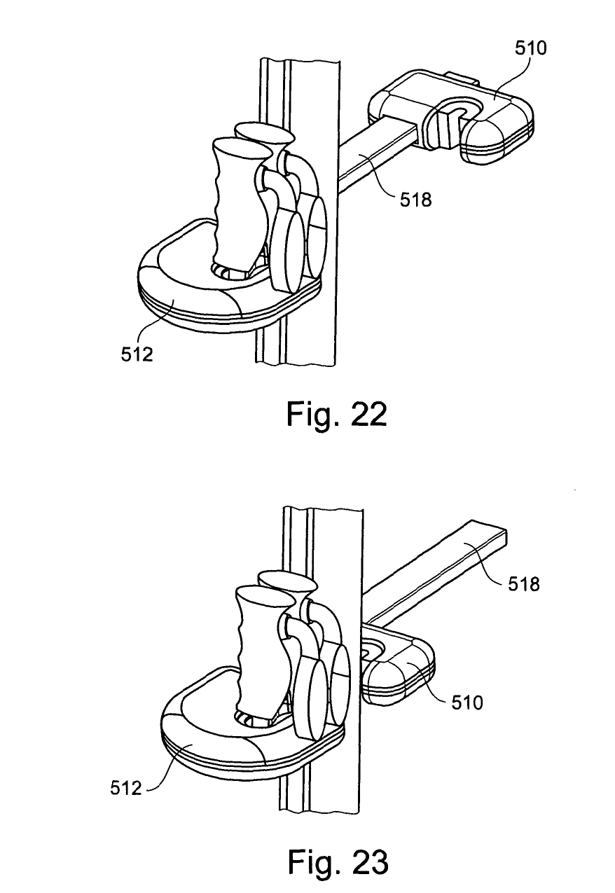

FIGS. 22 and 23 are expanded views of the clamping mechanism which shows the back clamp 510 and front clamp 512 connected by a strut 518. As shown in FIG. 23, the back clamp 510 may slide and lock along the length of the strut 518 thereby securing skis, skis and ski poles or snowboards between the front and back clamps.

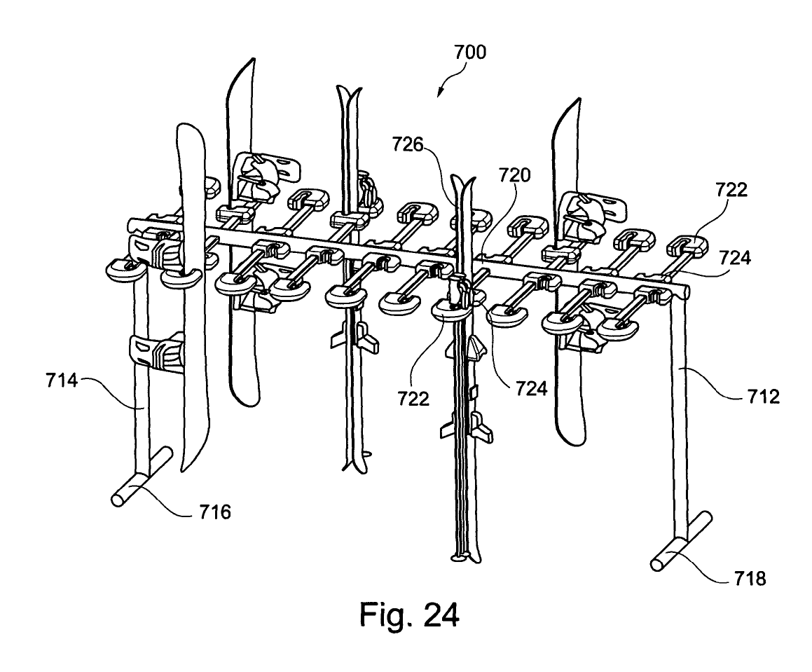

FIG. 24 is a further apparatus 700 which shows a clamping apparatus attached to two legs 712 and 714 comprising two feet 716, 718, respectively. As shown in FIG. 24 there is a plurality of clamping mechanisms with a back clamp 724 and a front clamp 722. The back clamp 724 may be slid against the front clamp 722 to provide a locking mechanism.

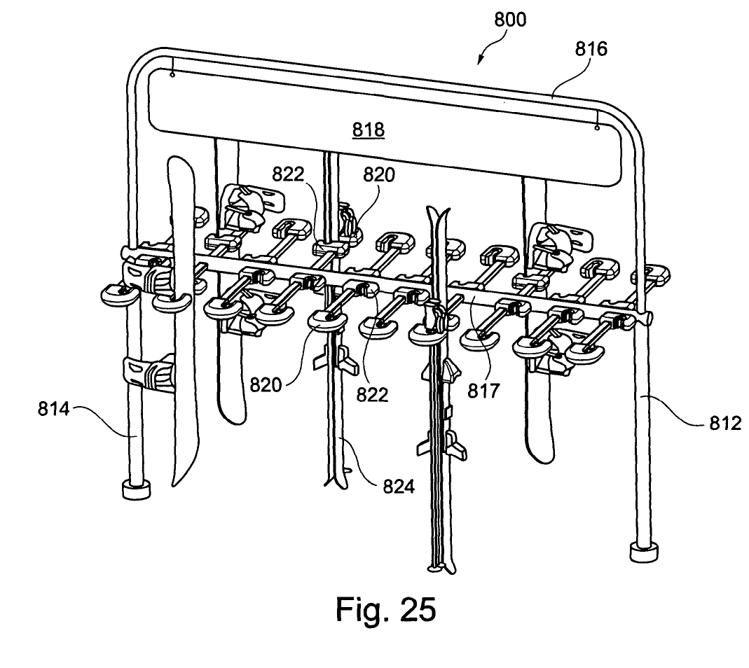

FIG. 25 is a further apparatus 800 which comprises a stand with two legs 812, 814 and an upper support member 816 onto which an advertising member 818 may be attached. The apparatus 800 comprises a horizontal support member 817 onto which there are a plurality of clamping mechanisms wherein a back clamp 822 may be slid against a front clamp 820 to provide a clamping mechanism.

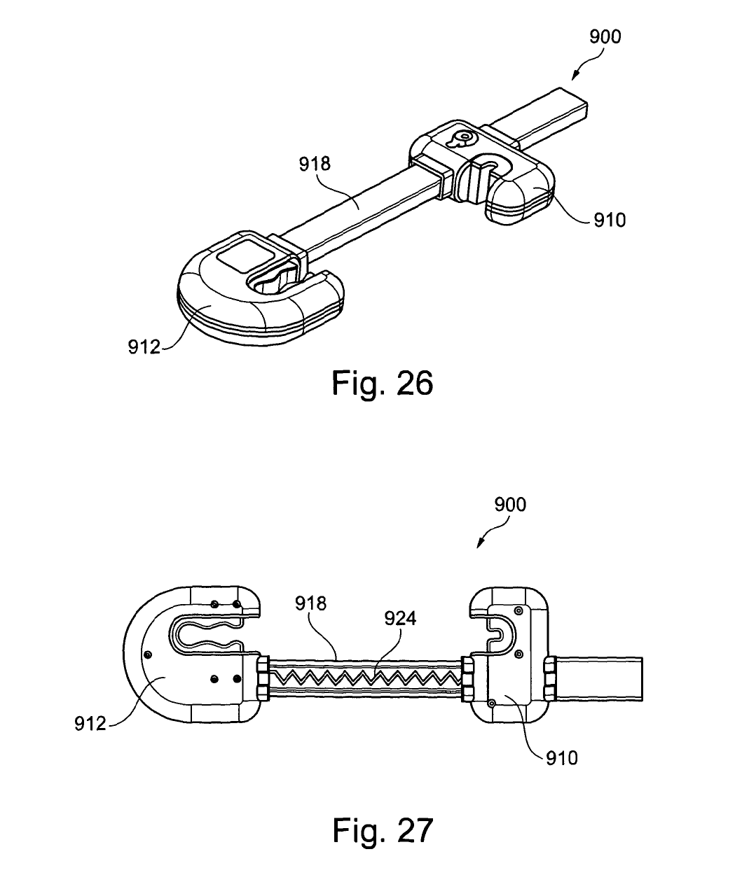

FIGS. 26 and 27 are views of a further clamping mechanism 900 according to the present invention. FIG. 26 is a perspective view of the clamping mechanism 900 and FIG. 27 and is a view of the underside of the clamping mechanism 900. As shown the clamping mechanism 900 comprises a back clamp 910 and a front clamp 912. The back and front clamps 910, 912 are bolted onto a strut 918 518 in such a way that the back clamp 910 can move easily backwards and forwards to engage onto articles such as skis, skis and ski poles or snowboards to be secured. FIG. 27 shows that there is a spiral cable 924 between the back and front clamps 910, 912 The spiral cable 552 is a power cable which supplies power to and sends instructions to the solenoid/linear actuator.

Whilst specific embodiments of the present invention have been described above, it will be appreciated that departures from the described embodiments may still fall within the scope of the present invention. For example, any suitable type of locking mechanism which may be remotely activated and deactivated may be used. Moreover, the locking mechanism may comprise any suitable type of mechanical locking means which are capable of securely fixing around at least one or more skis, skis and ski poles, ski poles and/or snowboards. Each locking apparatus may also be used to hold a ski or a pair of skis and/or a ski pole or a pair of ski poles. The apparatus may also be powered using any suitable means including that of solar, wind, battery and/or a fixed electrical source.

1-19. (canceled)

20. A secure ski, ski pole and/or snowboard locking apparatus, said secure ski, ski pole and/or snowboard locking apparatus comprising:
a support;
at least one locking mechanism connected to the support, said at least one locking mechanism capable of securely locking at least one or more skis, skis and ski poles, ski poles, and/or snowboards;
wherein said at least one locking mechanism is capable of being activated using a wireless control means.

21. A secure ski, ski pole and/or snowboard locking apparatus according to claim 20, wherein the ski, ski pole and/or snowboard locking apparatus is capable of preventing theft and being activated using a wireless control means.

22. A secure ski, ski pole and/or snowboard locking apparatus according to claim 20, wherein the wireless control means is a radio-frequency identification (RFID) system including that of cards or tags.

23. A secure ski, ski pole and/or snowboard locking apparatus according to claim 20, wherein the support comprises at least two or more or a plurality of vertical or substantially vertical legs.

24. A secure ski, ski pole and/or snowboard locking apparatus according to claim 23, wherein attached to the legs of the ski, ski pole and/or snowboard locking apparatus there is at least one or more horizontal or substantially horizontal support members, and wherein onto the horizontal or substantially horizontal support members there are at least one or more, at least two or more or a plurality of locking mechanisms which are capable of securely locking at least one or more skis, skis and ski poles, ski poles, and/or snowboards.

25. A secure ski, ski pole and/or snowboard locking apparatus according to claim 20, wherein the locking mechanisms are any suitable mechanical means which are capable of engaging with and clamping onto at least one or more skis, skis and ski poles, ski poles, and/or snowboards.

26. A secure ski, ski pole and/or snowboard locking apparatus according to claim 20, wherein the locking mechanism is a rotational locking mechanism comprising a series of ‘U’-shaped members and the ‘U’-shaped members form a snug fit around at least one or more skis, skis and ski poles, ski poles, and/or snowboards.

27. A secure ski, ski pole and/or snowboard locking apparatus according to claim 20, wherein the locking mechanism comprises a latch and a first slot capable of holding a snowboard, a second slot capable of holding a ski pole or ski poles and a third slot capable of holding a ski or a pair of skis.

28. A secure ski, ski pole and/or snowboard locking apparatus according to claim 20, wherein the operation of the locking mechanism is controlled by a pre-paid electronic wireless system including that of an RFID card or tag.

29. A secure ski, ski pole and/or snowboard locking apparatus according to claim 28, wherein payment is either made by scanning an RFID card or tag across a receiver on the locking apparatus or alternatively payment is made in advance for an RFID card or tag which allows the skier or snowboarder to use the locking apparatus for a pre-determined period of time; so that when the RFID card or tag for either means of payment is scanned across a receiver on the locking apparatus it is capable of identifying the specific user and therefore is capable of enabling an empty space for a skier or snowboarder to use to store at least one or more skis, skis and ski poles, ski poles, and/or snowboards.

30. A secure ski, ski pole and/or snowboard locking apparatus according to claim 20, wherein the locking apparatus comprises a series of LED lights which are capable of being used to notify skiers and snowboarders when locks are available and unavailable.

31. A secure ski, ski pole and/or snowboard locking apparatus according to claim 20, wherein the locking apparatus comprises solar (e.g. a solar panel), wind, battery and/or a fixed electrical source.

32. A secure ski, ski pole and/or snowboard locking apparatus according to claim 20, wherein the locking mechanism comprises a strut which has a fixed clamp at one end and along which a back clamp may slide and lock thereby securing at least one or more skis, skis and ski poles, ski poles, and/or snowboards.

33. A secure ski, ski pole and/or snowboard locking apparatus according to claim 20, wherein the locking mechanism comprises a back clamp which retracts to the back of the strut by the spring until the apparatus becomes operational by scanning an RFID card or tag across a receiver on the locking apparatus.

34. A secure ski, ski pole and/or snowboard locking apparatus according to claim 20, wherein the locking mechanism comprises a locking plate which upon the locking apparatus becoming operational allows the skier or snowboarder to pull the back clamp closed against the skis, skis and ski poles ski poles and/or or snowboards but prevents the back clamp retracting until the RFID card or tag is rescanned across a receiver on the locking apparatus, thereby securing at least one or more skis, skis and ski poles, ski poles, and/or snowboards between the front and back clamp.

35. A method of securing a ski, ski pole and/or snowboard said method comprising:
providing a support;
providing at least one locking mechanism connected to the support, said at least one locking mechanism capable of securely locking at least one or more skis, skis and ski poles, ski poles, and/or snowboards; and
wherein said at least one locking mechanism is capable of being activated using a wireless control means.
